(19) United States
(12) Patent Application Publication
(10) Pub. No.: US 2009/0195494 A1
(43) Pub. Date: Aug. 6, 2009

(54) LIQUID-CRYSTAL DISPLAY DEVICE AND ITS MANUFACTURING METHOD

(76) Inventor: Tomoyuki Ueda, Hyogo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/348,381

(22) Filed: Jan. 5, 2009

(30) Foreign Application Priority Data
Jan. 9, 2008 (JP) 2008-2620

(51) Int. Cl. G09G 3/36; G02F 1/13357

(52) U.S. Cl. 345/102; 349/69

(57) ABSTRACT

A liquid-crystal display device comprises; a display panel having a matrix array of pixel dots in red, green or blue color; a surface illuminant device that has white-light LEDs as light sources; one or more driver ICs, each of which includes three converter circuits respectively for the red, the green and the blue and performs a conversion to signal voltages from image data signals according to a respective conversion curve; and a nonvolatile memory in which data determining the conversion curves are stored after the data are attuned to variation in chromaticity of the white-light LEDs in the surface illuminant device so that said variation is compensated based on measurement of the chromaticity of each of the white-light LEDs.

### CROSS-REFERENCE TO RELATED APPLICATION

This application is based upon and claims the benefit of priority from the prior Japanese Patent Application No. 2008-002620, filed on Jan. 9, 2008; the entire contents of which are incorporated herein by reference.

### BACKGROUND OF THE INVENTION

This invention relates to a liquid-crystal display device that has, on its periphery, driver IC chips and is equipped with white-light LEDs (light-emitting-diodes) forming a backlight or frontlight of the display device. The invention also relates to manufacturing method of such liquid-crystal display device.

Liquid crystal display (LCD) devices and other flat-panel display devices are widely used in various fields as image display devices for personal computers, portable information devices or the like in various kinds; in view of their small depth dimension and small weight as well as small electric power consumption. In particular, the flat-panel devices have come to be widely used as the image-displaying devices for; the television sets, ranging from small portable ones to big wall hanging ones; small laptop computers, and other portable information terminals; and car navigation systems or the like.

An active-matrix LCD device is comprised of; a display panel having an array of pixels forming a display screen or viewing area; and driver system for inputting image signals or other signals to the display panel. The display panel is comprised of a matrix array substrate (hereinafter referred as array substrate) and a counter substrate, which are closely opposed to each other with a predetermined gap, and of a liquid crystal layer held in the gap. The array substrate has signal lines and scanning lines, which are arranged in a latticework on an insulator substrate such as a glass plate, and are overlapped to sandwich an insulator film. On each rectangular patch defined by the signal and scanning lines, a pixel electrode is disposed; and at around each crossing of the signal and scanning lines, a pixel-switching element is disposed. When to realize color display, a color layer of either of red, green and blue is arranged on each patch matching the pixel electrode to form a pixel dot of such color. On each pixel dot, extent of optical modulation through a liquid crystal layer is controlled by an image signal voltage applied between a counter electrode and the pixel electrode. Namely, at each pixel dot, transmittance or reflectivity for a light supplied by backlight or frontlight is controlled. In this way, a combination of three pixel dots respectively having red, green and blue color realizes a color display at a predetermined luminance and at a predetermined chromaticity, at each video frame.

Inputting of drive signals from the driver system to the display panel is made through connecting portions arranged on marginal areas of the display panel. Generally, arranged on the marginal areas are driver IC chips that generate output signals at predetermined timings by controlling signals inputted thereto. The driver IC chips are mounted directly on the marginal areas in a “chip on glass” (COG) arrangement, or in otherwise on flexible circuit boards referred as tape carrier packages (TCPs). In a matrix array substrate having a polysilicone layer pattern, driver ICs are formed on a marginal areas of the array substrate, by and at a time of forming of multilayer patterns and patterning.

The driver ICs on the margin areas are configured to convert image data inputted from an external driver system in accordance with a predetermined conversion curve, into image signal voltages; and to supply them to the pixel electrodes through the signal lines. Timing for supplying the signal voltage to a certain pixel electrode has to be synchronized with a timing the switching element is turned on by a voltage applied through the scanning lines. Thus, the driver ICs are provided with a timing controller that generates timing signals based on clock signals and synchronization signals, which are inputted from the external driver system. As the synchronization signals, there are adopted—(1) data enable signals, and/or (2) vertical and horizontal synchronization signals.

As a surface illuminant device that is a backlight or frontlight of the LCD device and is arranged as overlapped with the display panel, one formed of LEDs is recently investigated. When to form such a surface illuminant device, the LEDs of red, green and blue colors are arranged in a certain sequence, or white-light LEDs are arranged. When the surface illuminant device is of an edge light construction, one or more white-light LEDs are arranged along an edge of a light-guide plate. When the surface illuminant device is of a direct illumination construction, a plurality of the LEDs is arrayed along reverse face of the display panel.

Nevertheless, chromaticity (hue and colorfulness) and brightness of the LEDs are varied in a rather large extent among production lots or one to another. Variations of chromaticity are especially large in the white-light LEDs due to their varied conditions in manufacturing processes. Thus, it has been needed to select the LEDs having the chromaticity and brightness in a certain narrow range when to avoid unevenness in brightness and in coloring within the display screen or the viewing area. Such selection inevitably makes some of the LEDs become off-specification and unusable ones, and thus leads to increase of costs for the LEDs and thereby costs for the LCD devices. Moreover, if and when production and supply of the LEDs become squeezed or tight, production of the LCD devices would be affected more by sorting out of such off-specification ones.

In view of the above, JP-2001-271398A (Japan's patent application publication No. 2001-271398) describes that intensity and/or duty ratio of electric current applied to each of the white-light LEDs or other LEDs is modified as to modify the brightness and chromaticity of respective one of the LEDs. Meanwhile, JP-2006-091237A discloses a following technique: the driver system includes an image processor that modifies chromaticity values in image signal data, based on a “color conversion table” stored in a memory, in a manner that modified image signals are inputted to the driver IC chips on the marginal areas on the display panel; and the display panel has, on its marginal area outside of the viewing area, three optical sensors that respectively detect intensity of red beams, green beams and blue beams, and detected intensities are used to correct or adjust the “color conversion table”.

A technique disclosed in JP-2001-271398A has a disadvantage that due to arranging of such light modification circuits, capacity of the LEDs are not fully utilized and thus it is difficult to fully improve luminance level of the surface illuminant device. A technique disclosed in JP-2006-091237A has a disadvantage that an image processor has to be added into the driver circuit and the image processor is required to deal with whole of image data including red, green and blue color values; and resultantly, construction of the image processor becomes complex and production cost might be increased.

### BRIEF SUMMARY OF THE INVENTION

A liquid-crystal display device of the invention comprises; a display panel having a plurality of scanning and signal lines and having a matrix array of pixel dots in red, green or blue color, each of which is arranged for a respective crossing of the scanning and signal lines and is comprised of a pixel electrode and a switching element; a surface illuminant device that has white-light LEDs as light sources and supplies light-source beams to the display panel; one or more driver ICs, each of which is arranged on or along a marginal area of the display panel, performs a conversion to signal voltages from image data signals derived from an external driver system, and supplies the signal voltages to the signal lines at a timing based on clock and synchronization signals derived from the external driver system, where each of the driver ICs includes three converter circuits respectively for the red, the green and the blue, and each of the three converter circuits independently performs said conversion according to a respective conversion curve; and a nonvolatile memory in which data determining the conversion curve for the red, data determining the conversion curve for the green and data determining the conversion curve for the blue are stored after the data are attuned to variation in chromaticity of the white-light LEDs in the surface illuminant device so that said variation is compensated based on measurement of the chromaticity of each of the white-light LEDs.

A manufacturing method of the invention, of the liquid-crystal display device comprises; preparing a display panel having a plurality of scanning and signal lines and having a matrix array of pixel dots in red, green or blue color, each of which is arranged for a respective crossing of the scanning and signal lines and is comprised of a pixel electrode and a switching element; preparing a surface illuminant device that has white-light LEDs as light sources and supplies light-source beams to the display panel; preparing one or more driver ICs, each of which is arranged on or along a marginal area of the display panel, performs a conversion to signal voltages from image data signals derived from an external driver system, and supplies the signal voltages to the signal lines at a timing based on clock and synchronization signals derived from the external driver system, where each of the driver ICs includes three converter circuits respectively for the red, the green and the blue, and each of the three converter circuits independently performs said conversion according to a respective conversion curve; preparing a nonvolatile memory in which data determining the conversion curve for the red, data determining the conversion curve for the green and data determining the conversion curve for the blue are stored; measuring chromaticity of each of the white-light LEDs in the surface illuminant device; and modifying the data determining the conversion curve for the red, green or blue in a manner to compensate variation in chromaticity of the white-light LEDs based on said measuring.

By such construction, sorting out of non-typical ones or far-from-typical ones from the supplied white-light LEDs is no more needed and production cost of the LCD device is decreased.

### BRIEF DESCRIPTION OF THE SEVERAL VIEWS OF THE DRAWING

FIG. 1 is a block diagram showing a construction of a drive IC chip that is essential part of an LCD device as an embodiment of the invention;

FIG. 2 is a perspective view as a nearly-plan view, showing a detailed example of an over-all construction of the LCD device of the embodiment;

FIG. 3 is a graph showing an example of gamma curves respectively for three elementary colors (Red, Green and Blue); and

FIG. 4 is a CIE color space chromatography diagram indicating color temperatures.

### DETAILED DESCRIPTION OF THE INVENTION

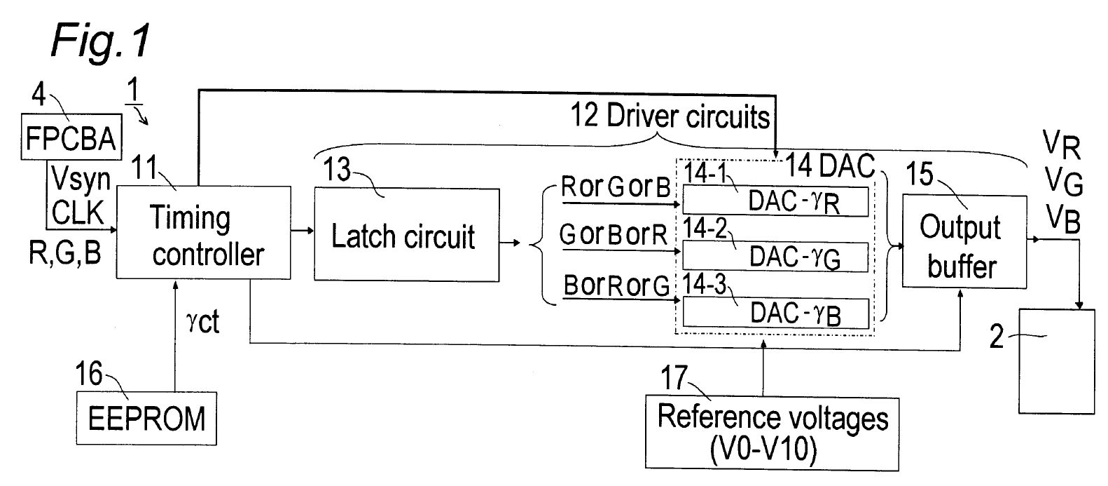

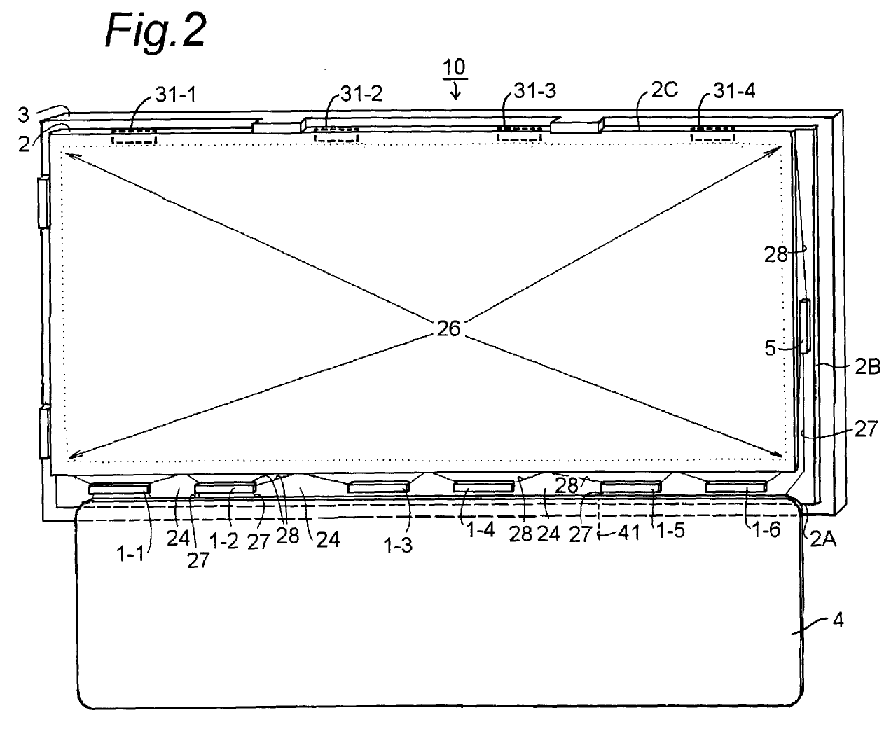

An LCD device and its manufacturing method according to an embodiment of the invention are explained by use of FIGS. 1-3. FIG. 2 is a perspective view as a nearly-plan view showing a detailed example of over-all construction of the LCD device 10; FIG. 1 is a block diagram showing a construction of an image-signal-line driver (X-driver) IC chip 1.

As shown in FIG. 1, an X-driver IC chip 1 includes a timing controller 11 and a driver-circuits part 12. In a preferred detailed example, the X-driver IC chip 1 has as its built-in elements; an EEPROM (Electrically Erasable Programmable Read-Only Memory) 16 storing a gamma conversion table γct; and a reference voltage generating circuit 17. The driver-circuits part 12 is comprised of a latch 13, which is a shift/data register latch, and a digital-to-analogue converter (DAC) 14 having a gamma correction function. Each of the DAC 14 is comprised of three monochromatic DACs 14-1, 14-2 and 14-3, which are respectively for red, green and blue and independent with each other, and each of which converts image data signals R, G, B of red, green or blue into signal voltages VR, VG, VB. Each of the monochromatic DACs 14-1, 14-2 and 14-3 has a gamma correction function for respective primary color among the red, green and blue.

When power line of the LCD device is turned on, then subsequently the image data signals R, G, B of each primary color as well as a horizontal synchronization signal Hsyn and a vertical synchronization signal Vsyn are sequentially inputted to the timing controller 11 from a flexible printed circuit board assembly (FPCBA) 4. At each interval in a time sequence, the timing controller 11 stores a series of image data signals R, G, B matching one scanning period, on a predetermined storage area on the latch 13 in the driver-circuit part 12. The timing controller 11 transmits output timing signals to an output buffer 15 in the driver-circuit part 12 so that the output buffer 15 outputs the signal voltages VR, VG, VB at a writing period for target pixel dots, or at a time a scanning line associated with the target pixel dots is supplied with voltage. The timing controller 11 reads out a gamma conversion table yct stored in the EEPROM 16, and transmits coefficients of gamma conversion for each of the three primary colors, to respective one of the monochromatic DACs 14-1, 14-2 and 14-3.

In the driver-circuits part 12 at each interval in a time sequence, a red-color DAC 14-1 for example reads out a series of digital signals from a storage area for red image data signals on the latch 13, and performs a gamma conversion based on gamma coefficients that are assigned to red color. Then, the red-color DAC 14-1 outputs a certain signal voltage VR based on a digital value obtained by the gamma conversion and on reference voltages supplied by a reference-voltage generator 17 as to be written in a predetermined area on the output buffer 15.

An example of overall construction of the LCD device 10 is described in below, in conjunction with FIG. 2. In an illustrated detailed example, viewing area 26 of the LCD device 10 has a diagonal dimension of 7-9 inches and an aspect ratio of about 2/1 as a widescreen display. The display panel 2 has, at its marginal area along a long side or along an “X-end face” 2A, a shelf-shaped connection area or an “X-margin connection area” 25 for inputting signals to the signal lines. On the X-margin connection area 25, six pieces of the X-driver IC chips 1-1 . . . 1-6 are directly mounted by the COG arrangement. An output portion of the FPCBA 4 is also mounted on the X-margin connection area 25, at its part outside of the X-driver IC chips 1. The FPCBA 4 has for example a controller IC and other mounted components. The display panel 2 has, at its marginal area along a short side or along a “Y-end face” 2B, a shelf-shaped connection area or a “Y-margin connection area” 29 for inputting signals to the scanning lines. On the Y-margin connection area 29, one Y-driver IC chip 5 is directly mounted by the COG arrangement. Output wirings 41 of the FPCBA 4 electrically connected through IC input wirings 27 on the display panel 2, to input signals or voltages to bumps of the driver IC chips 4 and 5. And, output bumps of the driver IC chips 4 and 5 are electrically connected through output wirings 38 on the display panel 2, to signal lines or scanning lines within the viewing area 26.

A backlight unit 3 that is arranged on and along a reverse face of the display panel 2 is comprised of; white-light LEDs 31 as light sources, a light-guide plate, and a resin frame housing the LEDs 31 and the guide plate. In an illustrated detailed example, four pieces of the white-light LEDs 31-1 . . . 31-4 are arranged along another long side or along an “opposite-X-end face” 2C, of the display panel 2. Each of the white-light LEDs 31-1 . . . 31-4 is a package product having a reflector and thus has a certain extent of directionality to emit light beams toward the X-end face 2A.

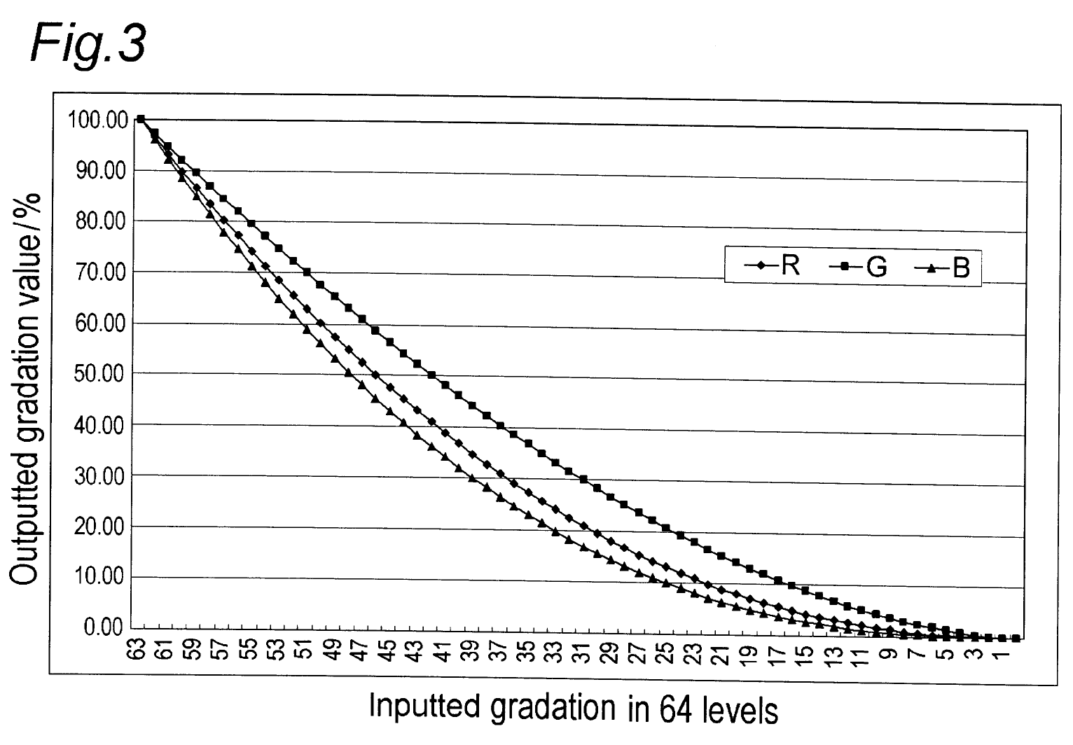

FIG. 3 shows a detailed example of gamma curves that are set for each of the X-driver IC chips 1. In an illustrated example, digital signals in 64 levels of gradation are converted to analogue signals eventually determining transmittance (%) or reflectivity (%) on the pixel dots, or to digital signals in 100 levels of gradation. In the illustrated example, a gamma curve for such converting of blue-color image data signals B has a relatively large exponent when the gamma curve is represented as a power function; and a gamma curve for such converting of green-color image data signals G is given a relatively small exponent in a manner to become by some extent more similar to a straight line.

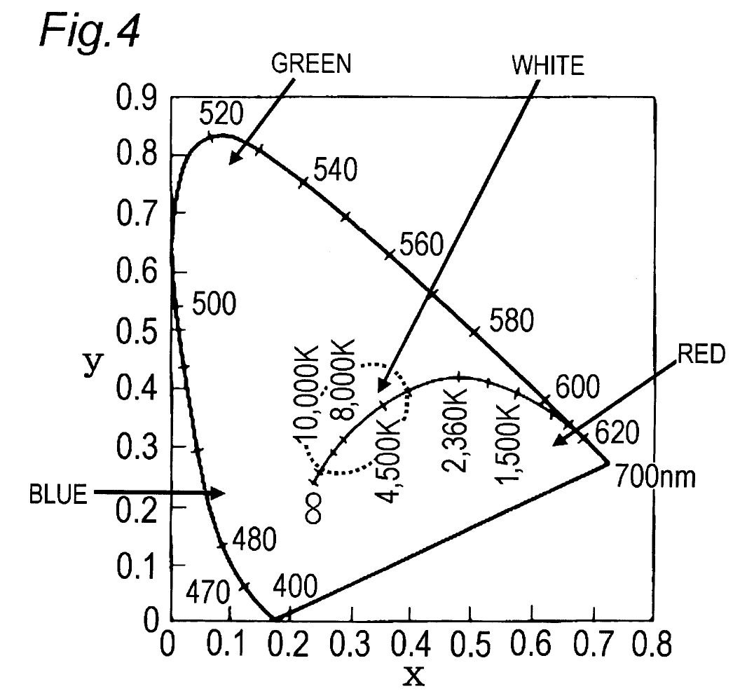

FIG. 4 shows a CIE color space chromatography diagram for explaining color temperatures. When to produce a white-light LED chip, a blue LED is combined with yellow fluorescent material as to emit white light beams, for example. As a result of slight variations in conditions on courses of such away of production, LED chip products would significantly include some having a deviation to blue color and some having a deviation to yellow color. Thus, the LED chip products would include a significant ratio of those having irregular or overly-varied color temperatures or chromaticity, in a range of 6000K±500K for example. By independently providing the three gamma curves for the three primary colors as in FIG. 3, the color temperature of white-color displaying on the viewing area is modified to become closer to a target value or a typical value. Resultantly, even with adopting irregular LED chips that would have been sorted out in conventional technology, it is achievable a good color display performance matching with an occasion adopting only regular ones of the LED chips having a narrow range of color temperatures.

When two or more of the white-light LEDs 31 are used as in FIG. 2, certain pixel areas are supplied with light beams from two or more of the white-light LEDs 31. To cope with this, the gamma curves of the three primary colors may be decided by taking account of mixing ratio of the light beams from the LEDs 31 on an occasion-to-occasion basis. Then, coefficients determining such gamma curves are stored in the EEPROM 16 or other nonvolatile memory. When two or more of the X-driver IC chips 4 are used; for each of the X-driver IC chips 4, optimal ones of the gamma curves and thereby coefficients determining them may be decided and stored in the nonvolatile memory. By such correction or compensation for variations in the color temperature of the LEDs, unevenness in color temperature would become small enough to be not recognizable by a user even when white color is displayed throughout the viewing area 26.

In the above, it is explained that each of pixel dots on the display panel is either of red, green and blue ones. Nevertheless, even when white pixel dots are arranged on the display panel in addition to the red, green and blue ones, compensation of the color temperature same as above is achievable. Meanwhile, it is explained in the above that the X-driver IC chips are mounted by the COG arrangement. Nevertheless, X-driver ICs may be formed simultaneously with forming of TFTs within the viewing area, and in otherwise may be ones mounted on the TCPs or other flexible wiring boards, without causing a slightest difference in advantage of the invention. Moreover, the nonvolatile memory for storing the coefficients of the gamma conversion or conversion table may be a flash memory mounted on the FPCBA 4 or on other part of the LCD device 10, without causing a slightest difference in the advantage.

What is claimed is:

1. A liquid-crystal display device comprising:
a display panel having a plurality of scanning and signal lines and having a matrix array of pixel dots in red, green or blue color, each of which is arranged for a respective crossing of the scanning and signal lines and is comprised of a pixel electrode and a switching element;
a surface illuminant device that has white-light LEDs as light sources and supplies light-source beams to the display panel;
one or more driver ICs, each of which is arranged on or along a marginal area of the display panel, performs a conversion to signal voltages from image data signals derived from an external driver system, and supplies the signal voltages to the signal lines at a timing based on clock and synchronization signals derived from the external driver system,
where each of the driver ICs includes three converter circuits respectively for the red, the green and the blue,
and each of the three converter circuits independently performs said conversion according to a respective conversion curve; and
a nonvolatile memory in which data determining the conversion curve for the red, data determining the conversion curve for the green and data determining the conversion curve for the blue are stored
after the data are attuned to variation in chromaticity of the white-light LEDs in the surface illuminant device so that said variation is compensated based on measurement of the chromaticity of each of the white-light LEDs.

2. A manufacturing method of a liquid-crystal display device comprising:
preparing a display panel having a plurality of scanning and signal lines and having a matrix array of pixel dots in red, green or blue color, each of which is arranged for a respective crossing of the scanning and signal lines and is comprised of a pixel electrode and a switching element;
preparing a surface illuminant device that has white-light LEDs as light sources and supplies light-source beams to the display panel;
preparing one or more driver ICs, each of which is arranged on or along a marginal area of the display panel, performs a conversion to signal voltages from image data signals derived from an external driver system, and supplies the signal voltages to the signal lines at a timing based on clock and synchronization signals derived from the external driver system,
where each of the driver ICs includes three converter circuits respectively for the red, the green and the blue, and each of the three converter circuits independently performs said conversion according to a respective conversion curve;
preparing a nonvolatile memory in which data determining the conversion curve for the red, data determining the conversion curve for the green and data determining the conversion curve for the blue are stored;
measuring chromaticity of each of the white-light LEDs in the surface illuminant device; and
modifying the data determining the conversion curve for the red, green or blue in a manner to compensate variation in chromaticity of the white-light LEDs based on said measuring.

3. A manufacturing method according to claim 2, wherein each of the converter circuits are digital-to-analogue converter and the nonvolatile memory is an Electrically Erasable Programmable ROM (EEPROM).
